(19) United States
(12) Patent Application Publication
(10) Pub. No.: US 2008/0292426 A1
(43) Pub. Date: Nov. 27, 2008

(54) FASTENING DEVICE HAVING A RETENTION ELEMENT AND METHOD OF MANUFACTURE

(76) Inventors: Gerald F. SNOW, Almont, MI (US); Charles M. Stempien, Wolverine Lake, MI (US)

Correspondence Address: WINSTON & STRAWN LLP;PATENT DEPARTMENT, 1700 K STREET, N.W., WASHINGTON, DC, 20006, US

(21) Appl. No.: 12/124,832

(22) Filed: May 21, 2008

Related U.S. Application Data
(60) Provisional application No. 60/939,268, filed on May 21, 2007.

(51) Int. Cl. F16B 41/00; F16B 19/08

(52) U.S. Cl. 411/258; 411/361; 470/28; 427/284

(57) ABSTRACT

A fastening device such as a rivet collar that includes a retention element is disclosed. The retention element enhances the retention of a fastener within the fastening device by frictionally engaging the fastener. The retention element comprises a heat resistant base polymer, such as a reactive hot melt, an ethylene acrylic acid copolymer, or a polyethylene polymer blend, that does not melt or become tacky even at high temperatures, and therefore has high stability even under extreme storage conditions. Also disclosed is a method of forming such retention element on a fastening device.

### CROSS-REFERENCE TO RELATED APPLICATIONS

This application claims the benefit of U.S. Provisional Patent Application No. 60/939,268, filed May 21, 2007, the contents of which are incorporated herein by reference thereto.

### FIELD OF THE INVENTION

The invention relates to a fastening device having a retention element that provides enhanced retention of a fastener within the device.

### BACKGROUND OF THE INVENTION

Fastening systems with male and female components, such as a rivet fastening system, are well known. One type of traditional rivet fastening system includes a rivet pin and a collar. The rivet pin is inserted through holes in two panels being fastened, and the collar is placed over the pin. An installation tool pulls the pintail of the rivet pin while pushing on the collar to remove any gap between work surfaces. The tool then swages the collar into the locking grooves of the rivet, causing the collar to lengthen and develop clamp around the rivet. When swaging of the collar is complete, the tool continues to pull until the pintail of the rivet breaks flush with the top of the collar. Such rivet fastening system allows a wide grip range and high consistent tensile strength that is required in heavy duty, high vibration applications.

Because it is desirable to ensure that the collar stays on the rivet after assembly but before final setting of the rivet, it has been suggested to provide a retention feature on the collar. For example, it is known to provide an adhesive retention element made of non-reactive polyamide-based hot melt on the collar. The non-reactive polyamide hot melt adhesive, however, remains tacky to touch after being applied and solidified on collar, and becomes even tackier at high temperatures of about 100° F. or higher. Thus, the non-reactive polyamide hot melt can be unpleasant to handle and can interfere with rivet tooling by gumming up the tool and physically upsetting the rivet installation at a temperature higher than 100° F. In addition, such non-reactive polyamide hot melts must be stored and used under certain conditions and at a temperature of 0-100° F. for safety reasons.

It has also been suggested to provide a retention feature on a rivet shank. U.S. Pat. Nos. 5,518,768 and 6,025,019 disclose depositing a droplet or bead of thermoplastic or thermoset material such as polyamide or an olefin resin to form a retention element on an exterior surface of a male fastener or rivet shank that is to be driven, but does not envision using or providing the material in a bore of a female portion of a rivet system.

The preparation of a male fastener according to these patents, however, requires a complex manufacturing process. For example, the fastener must be fixed in some manner, so that the retention element material can be deposited or sprayed on the desired portion of the fastener. Further, because of the size and shape of the male fastener portion, it is difficult to apply the retention element material with control and precision in a simple and inexpensive manner, and multiple applications may be required to achieve the desired coverage and thickness. Also, because a liquid or powder material applied on a fastener will tend to flow out of or fall off the shank, some control mechanism, e.g., applying centrifugal force by rotating the fastener, is necessary. Application of the material by spraying can also require additional treatment to remove spattering or excess spraying. In addition, unless the retention element is applied through the entire length of the fastener shank, the placement of the retention element must necessarily be localized for individual applications and would depend on the thickness of the work pieces to be joined to ensure that the retention element contacts the collar.

Fasteners of types other than rivets and other fasteners that are deformed for affixing two pieces have used self-locking features. Typically, such features are used to keep the fasteners from unscrewing after final assembly, instead of relying on the deformation of a portion of the fastener to provide the final fastening strength. For example, threaded nut fasteners having a self-locking feature are disclosed in U.S. Pat. No. 3,830,902, which discloses forming a resiliently deformable plastic patch, such as a polyamide patch, on threads of a nut; U.S. Pat. No. 4,262,038, which discloses substantially uniformly coating the inside threads of a nut with a powdered thermoplastic material such as nylon; U.S. Pat. No. 4,282,913, which discloses forming a torque-type self-locking nut having a self-locking element of a thin-walled, washer type annular ring with a thread-impressionable thermoplastic material such as nylon; and U.S. Pat. No. 6,474,919, which discloses applying a 360° coating of a nylon powder material on the internal bore or threads of a fastener using centrifugal force. The self-locking features disclosed in these patents are all based on polyamide or nylon.

Threaded bolt or screw-type fasteners having a self-locking or self-sealing feature are also disclosed. For example, U.S. Pat. No. 3,093,177 discloses a self-locking threaded fastener having a pellet of a nylon plastic composition fused on a surface of the thread by heat and pressure; U.S. Pat. No. 4,399,166 discloses a threaded fastener having a friction producing patch; U.S. Pat. No. 5,122,020 discloses a reusable self-locking fastener that includes a metallurugically bonded metal patch as a self-locking feature; and U.S. Pat. No. 5,141,375 discloses a self-sealing threaded fastener having an integral sealing element of olefin material bonded directly to the bearing shoulder and/or upper shank of the fastener, to provide a moisture-tight seal between the fastener and the secured work piece.

Therefore, what is needed is a fastening system having an improved retention element that can withstand high temperatures without becoming tacky and that can be manufactured in a simple and cost-effective process.

### SUMMARY OF THE INVENTION

The invention relates to an improved fastening device, such as a rivet collar, that is capable of receiving a fastener. The fastening device is preferably at least a two-part fastener, and includes a retention element adhered to an interior surface of a first portion that receives a second portion of the fastener, such that the retention element frictionally engages the second portion and retains the two portions together prior to engaging them by plastic deformation.

The retention element preferably comprises a heat resistant polymer as the base polymer. In an embodiment, the heat resistant polymer is physically and chemically stable at least up to a certain temperature, for example, about 150° F. or higher, such that the retention element does not melt or become tacky up to such temperature. In one embodiment, the heat resistant polymer is an ethylene acrylic acid copolymer, a polymer blend comprising polyethylene and polyethyl methacrylate, or a combination thereof. In another embodiment, the heat resistant polymer is a reactive hot melt, such as urethane reactive hot melt. The retention element can further comprise at least one additive, such as a cross-linking agent, an adhesion promoting agent, a blowing agent, and a combination thereof.

The invention also relates to a method of forming a retention element in the interior of a first, female portion of a fastening device having a bore open at both ends adapted to receive a second, male portion. The preferred method comprises preheating the fastening device to a temperature above the melting point or flow point of the heat resistant polymer; applying a discrete shot of a retention element material comprising the heat resistant polymer onto an interior surface of the bore; heating the retention element material at least to the melting point or flow point of the heat resistant polymer to liquefy the retention element material; and cooling the device to resolidify the retention element material. The retention element so formed is capable of engaging and retaining the second fastener portion received in the first portion, while not melting or becoming tacky even at high temperatures, up to the melting point of the heat resistant polymer. The preferred retention element retains the first and second portions such that it prevents the first portion from falling or vibrating off the second portion, and can be released, such as by hand by grasping with a user's fingers or by a tool used to assemble the two portions before deforming one onto the other.

### BRIEF DESCRIPTION OF THE DRAWINGS

The above features and other advantages of the invention will become better understood by reference to the following detailed description and the accompanying drawings wherein:

FIG. 1 is a perspective view of a collar having a retention element according to an embodiment of the invention;

FIG. 2 is a cross-sectional view of a collar having a retention element according to an embodiment of the invention;

FIG. 3 is a top view of a collar having a patch-like retention element according to an embodiment of the invention;

FIG. 4 is a schematic illustration of the apparatus used to apply a retention element on a fastening device according to an embodiment of the invention;

FIG. 5 is an illustration of the deposition of a retention element material on an internal surface of a collar by a dispenser according to an embodiment of the invention; and

FIG. 6A to 6D are step-by-step illustration of the rivet installation process according to an embodiment of the invention.

### DESCRIPTION OF THE PREFERRED EMBODIMENTS

The invention relates to a fastening device such as a rivet collar and other such fastener receiving members that includes a retention element made of a soft thermoplastic or thermoset polymer material. The retention element facilitates the temporary retention of a second fastener portion within a first fastener portion, such as by frictionally engaging the two portions, and provides enhanced resistance to movement and unintentional disassembly of the fastener. The retention element is preferably sufficiently softer than the first and second fastener portions so that it does not substantially impair the final strength of the fastener when the two portions are plastically deformed to couple one with the other or substantially increase the force requirements to set the two portions with each other. Advantageously, the retention element according to the invention does not become tacky or sticky even at high temperatures, and therefore is capable of withstanding heat up to the melting point of the polymer.

In a preferred embodiment, the first portion of the fastener is a collar, which can have any desired size, cross-sectional shape, e.g., a cylindrical or square cross-section, and structural or design features, e.g., a flange or a smooth, ribbed or threaded internal portion, and has a bore that extends completely through one axial end to the other. The collars can be of the flanged and unflange types. The second portion of the fastener is a pin, e.g., a rivet pin, which has a size and shape suitable for inserting into the first portion. In a further embodiment, at least a part of the second portion includes circumferential ridges, or alternatively threads, into which the first portion is swaged by plastic deformation. The fastener portions are used to fasten at least one work piece. As used herein, the term “work piece” is understood to mean at least one body that is capable of receiving and being fastened by a fastener.

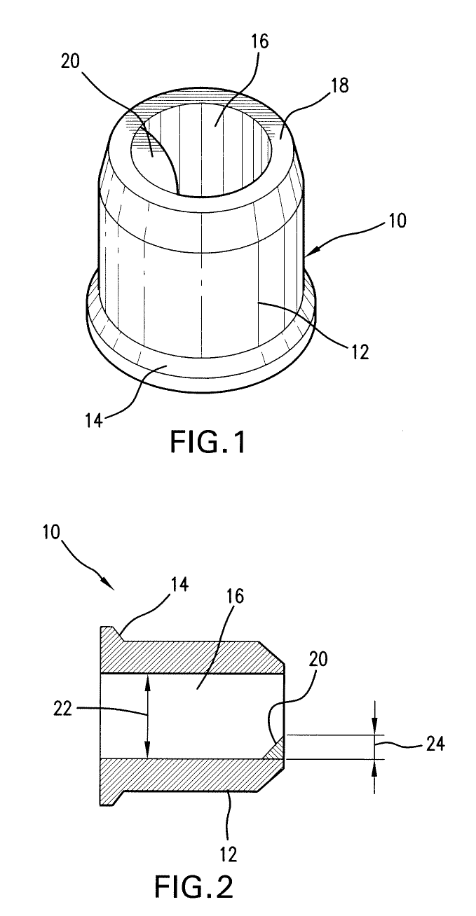

Referring to FIGS. 1 and 2, a first fastener portion in the form of a collar 10 is shown. The collar 10 is preferably of unitary construction, and has a cylindrical body 12 and a flange 14, which extends radially from the body 12. During assembly, the flange 14 would be placed over the work piece while the end 18 opposite the flange 14 is exposed. As shown, the cylindrical interior bore 16 of the collar, having a diameter 22, has a generally smooth surface configured to engage ridges and grooves, or alternatively threads, of the fastener during installation and swaging. The collar is formed of a rigid structural material such as metal, and can be coated with a suitable coating material. In an embodiment, the collar is formed of carbon steel or aluminum and coated with a zinc chromate or cadmium chromate finish. Other rivet materials are suitable.

The collar 10 includes a retention element 20 that is attached to, and extends from, at least a portion of the interior surface 16. The retention element 20 is preferably a free-form patch of limited axial and circumferential extent adhered to an interior surface of the collar.

In the embodiment shown in FIG. 2, where the collar 10 has an inner diameter 22, the retention element 20 extends from the interior surface 16 inwardly toward the center axis of the collar to a length 24. In an example, for a collar 10 having an inner diameter 22 of about 0.650 to 0.665 inches, the retention element 20 extends from the interior surface 16 to a length 24 of up to about 0.3 inches, preferably up to about 0.25 inches, and more preferably up to about 0.2 inches.

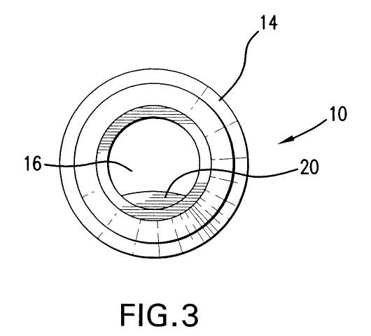

In the embodiment shown in FIG. 3, the retention element 20 is attached at a portion of the interior surface 16 proximate the end 18 opposite the flange 14, and has a volume that extends inwardly toward the center axis of the collar. Alternatively, the retention element can run from an interior surface 16 proximate the flange 14 through the opposite end 18, with a substantial portion of the retention element extending proximate the end 18, or can extend in a location between the ends. In an example, the retention element takes up to about 3%, and more preferably up to about 2%, of the internal volume of the bore. For example, for a collar having a diameter of ⅝ inches, with an inner diameter of about 0.650 to 0.665 inches, and a height of about 0.929 to 0.959 inches, the retention element has a volume of up to about 0.01 inch³.

The collar according to the invention can be used to fasten any work pieces with holes or openings therein that extend through the work piece. A rivet pin, having a head portion, such as a manufactured head, and a tail or pintail portion, such as a shank, is inserted through the openings of the work pieces. The pintail or shank preferably has a surface configured to engage a collar once the collar is plastically deformed, preferably a ridged or threaded surface, or such other surface known in the art. The collar is then placed over the pintail, such that the retention element extending from the collar frictionally engages the pintail, and the pin and the collar resist disassembly until the final installation and swaging of the collar into the ridges or threads of the pin. In a preferred embodiment, the retention element is placed proximate the end opposite the flange, to facilitate the initial insertion and engagement of the pin with the collar. In this manner, the pin will encounter no increased friction from the retention element when initially being inserted into the collar, but will frictionally engage the retention element as it passes through the collar. The rivet is set using an installation tool, which plastically deforms the collar to lengthen and squeeze to tighten clamp around the pin. When swaging of the collar is complete, the tool breaks the pintail flush with the top of the collar.

The retention element preferably comprises, as a base polymer, a thermoplastic or thermoset polymer that is physically and chemically resistant to prolonged exposure to high temperatures. As used herein, the terms “heat resistant polymer” and “heat resistant retention element” are understood to mean that the polymer or the retention element is physically and chemically stable and does not melt or become tacky in heat or high temperature conditions. In an embodiment, the heat resistant polymer is physically and chemically resistant to prolonged exposure to a temperature as high as about 150° F. or higher. In a further embodiment, the heat resistant polymer is physically and chemically resistant to prolonged exposure to a temperature as high as about 250° F. or higher. The retention element, as well as the base polymer, is preferably soft, flexible, and compressible compared to the material(s) of the first and second fastener portions.

In an embodiment, a base polymer suitable for the retention element according to the invention has a sufficient viscosity, in addition to the heat resistant properties, such that, when heated to its melting temperature or to a sufficiently high temperature, e.g., the flow point of the polymer, the polymer flows over a surface of the fastener portion to wet and form an intimate contact with the surface, but solidifies into a coherent unitary body when cooled to form a patch extending over a surface of the fastening device. As used herein, the term “flow point” is understood to mean the temperature at which the base polymer starts to exhibit flow characteristics but retains sufficient viscosity to remain as a coherent body. Depending on the type of the polymer, the flow point can be the glass transition temperature of the polymer or can be between the glass transition temperature and the melting point of the polymer. Other properties of a preferred base polymer include relatively low moisture absorption, high resistance to abrasion and to common chemicals, and high strength, toughness and resiliency. The base polymer should preferably be available in particulate form, more preferably fine powder form, or be capable of being reduced to particulate or fine powder form. The base polymer should also be capable of adhering directly to the material of the fastening device with a firm bond, and preferably requires no more than simple and inexpensive preparation of the fastening device, such as cleaning and heating, to obtain such firm bond. It is also desirable that the polymer has a melting point or flow point well below the temperature at which it begins to degrade or decompose so that complex or expensive heating controls would not be required.

According to an embodiment, the heat resistant base polymer comprises ethylene acrylic acid (EAA) copolymer (e.g., Corvelt® DG series materials, such as Corvel® DG 9004, available from Morton International Specialty Chemicals Group of Reading, Pa. and Nucrel® manufactured by DuPont Packaging and Industrial Polymers of Wilmington, Del.), polyethylene, polyethyl methacrylate, acrylic urethane, acrylic monomer, polyvinyl chloride (PVC), a polymer blend containing one or more of these polymers, or a combination thereof.

In an embodiment, the heat resistant base polymer comprises a blend of polyethylene and polyethyl methacrylate. The polymers can be blended in any desired ratios. In an example, polyethylene is included in an amount of at least about 30%, preferably at least about 50%, and more preferably at least about 60%, by weight of the blend. Polyethyl methacrylate is included in an amount of at least about 10%, preferably at least about 15%, and more preferably at least about 20%, by weight of the blend. Polyethylene is included in an amount of at most about 90%, preferably at most about 85%, and more preferably at most about 80%, by weight of the blend. Polyethyl methacrylate is included in an amount of at most about 70%, preferably at most about 60%, and more preferably at most about 50%, by weight of the blend. A preferred example of a polyethylene-polyethyl methacrylate blend includes polyethylene in an amount of about 50 to 75% and polyethyl methacrylate in an amount of about 25 to 50%, by weight of the blend. A further preferred example of a polyethylene-polyethyl methacrylate blend includes polyethylene in an amount of about 70% and polyethyl methacrylate in an amount of about 30%, by weight of the blend.

In another embodiment, the heat resistant base polymer comprises a reactive hot melt. A reactive hot melt is applied to the first fastener portion in uncured form, and cures after application when certain curing conditions are met. In an embodiment, the reactive hot melt is cured in the presence of moisture. Depending on the amount of moisture required for curing, the moisture already existing in the air can be sufficient to cure the reactive hot melt, or additional moisture can be provided. For example, water can be sprayed on the reactive hot melt to accelerate its curing. Reactive hot melts produce very durable, highly elastic bonds that can withstand temperature extremes. Reactive hot melts used in the present retention element are different from non-reactive hot melts, such as polyamide-based hot melts, and exhibit different chemical and physical characteristics. For example, a reactive hot melt requires certain curing conditions, such as moisture, to cure, and this curing is “irreversible”: once the reactive hot melt is cured and hardened, it remains in its cured state even in elevated temperatures and does not become tacky like polyamide hot melts, which can become pliable and tacky at high temperatures. Thus, the reactive hot melt has better temperature stability than non-reactive, polyamide-based hot melts. Examples of preferred reactive hot melts include urethane reactive hot melt (e.g., PUR-FECT LOK® series materials, such as PUR-FECT LOK® 475A comprising 4,4′-diphenylmethane diisocyanate, available from National Starch & Chemical Company of Bridgewater, N.J.).

In addition to the heat resistant base polymer, the retention element can include additives and agents that do not adversely affect or react with the base polymer. Examples of such additives include a cross-linking agent (e.g., diisocyanate), which can be used to form a polymer matrix in the retention element to maintain its volume over time; an adhesion promoter (e.g., a diacrylic compound), which promotes the adhesion of the retention element to the device; and an expansion or blowing agent, which forms gases to create a foamy, cellular structure and promotes expansion of the retention element during the formation to increase its volume. The blowing agent can be a physical blowing agent or a chemical blowing agent, such as azal amid dicarbon. Additional additives include a catalyst for accelerating the curing process; a filler (e.g., powdered nylon, glass, silicon, clay, graphite, or metal); an anti-corrosion agent (e.g., zinc phosphate); an anti-bacterial agent; and a pigment. An additive is included in any suitable amount, depending on the type of the additive and the final composition. If desired, a primer coating can be applied upon a surface of the fastening device before applying the retention element, to enhance adhesion of the retention element to the device and/or to protect the finish of the device during subsequent treatments.

Advantageously, because of the heat resistant characteristics of the base polymer, the retention element according to the invention is stable in high temperature environments, and does not physically disintegrate or become tacky at high temperatures, preferably up to at least about 150° F. and more preferably up to at least about 250° F. The retention element is also preferably stable in humidity because the base polymer would exhibit relatively low moisture absorption once cured or hardened. For example, when the base polymer comprises reactive hot melt that is cured by moisture, the cured polymer would tend to exhibit relatively low moisture absorption. Other polymers described herein, including EAA copolymers, polyethylene, and polyethyl methacrylate, also tend to exhibit relatively low moisture absorption. The retention element also has strength, toughness and resiliency adequate for typical rivet installations and other fastening applications, and can withstand a pull-off force of up to about 3 lbs, or at least about the weight of, and more preferably at least about three times the weight of, the first or second fastener portions. The force withstood is preferably sufficient to allow the second fastener portion to be inserted into the first fastener portion, and to prevent these from falling or otherwise coming apart or sliding with respect to each other unintentionally.

The retention element can be applied to the first fastener portion by any suitable method. According to an embodiment, the retention element is deposited in particulate form, preferably as fine powder, e.g., as a mixture of powdered resin of the base polymer and other powder additives, onto an interior wall of the first fastener portion using a depositor that is capable of depositing a predetermined amount of particulate materials. For example, the retention element can be provided as a powder of about 100 to 500 mesh. In another embodiment, the retention element is applied in a liquid or gel form using a dispenser that is capable of depositing a predetermined amount of such liquid or gel material. In a further embodiment, the retention element is applied as a mixture of particulate, liquid, and/or gel forms, for example, a gel containing powder particles. Alternatively, the retention element can be adhered or otherwise applied as a unitary piece to the first fastener portion.

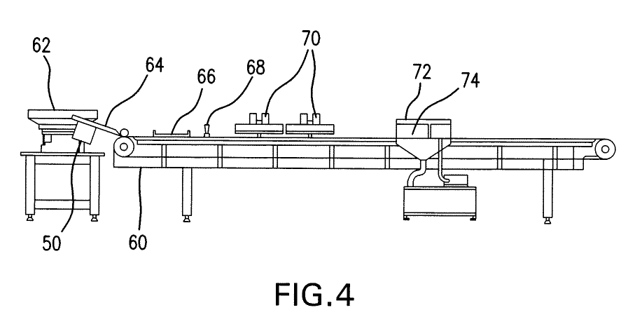

In the example shown in FIG. 4, various processing stations are provided to effect the application of the retention element on fastening devices 50, which are female portions of two-part fasteners. The fastening devices 50 are carried through the stations by any suitable conveyor mechanism, such as a transport belt 60. The fastening devices 50 are loaded onto the transport belt 60 by a suitable feeding means such as a feeder bowl 62 connected to a down-sloping track 64. Fastening devices 50 in the feeder bowl 62 are continuously fed to the down-sloping track 64, which loads the devices onto the transport belt 60.

Optionally, before the devices are loaded on the transport belt, or at any time before the application of the retention element material onto the devices, the devices can be cleaned to remove dusts and contaminants, which would enhance the adhesion of the retention element on the device.

The devices 50 pass through a first heating station 66, where the devices are preheated to a temperature above the melting point or flow point of the base polymer of the retention element but below the melting point of the fastening device material. Preferably, the devices are preheated to a temperature of at least about 300° F., depending on the underlying material of the device. For example, a carbon steel device is preferably heated to about 400° F., a cast steel device can be heated to about 350° F., and an aluminum device can be heated to about 425° F. The devices can be preheated by induction, radiation, conduction, convection or any other suitable heating means. For example, an induction heater, an infrared heater, an oven or a furnace, a heat bath, a light source (e.g., a laser or lamp), a flame, or any other heater can be used.

Such preheating improves the adhesion of the polymer resin, especially the powdered polymer resin, on the device and maximizes the ability of the powder resin to form a relatively large, discrete deposit. In an embodiment, the preheating enables the powder resin to melt immediately upon contact with the preheated device such that additional resin particles can be electrostatically attracted to the device. Thus, the preheating achieves a larger, thicker deposit of the retention element material to be deposited or coated on the device than possible with known nonelectrostatic coating methods. Because the present process utilizes electrostatic coating in a preferred embodiment, the polymer(s) of the retention element should preferably be capable of such electrostatic coating in powder form, i.e., is polar in powder form. The surface of the fastening device to which the powder retention element material is deposited should preferably also be conductive. Metal fastening devices and metal or non-metal devices coated with a conductive coating provide a suitable conductive surface.

The preheated devices 50 then pass under a dispensing mechanism, which includes a dispenser 68. The dispenser can be a gun, a nozzle, or such other device capable of discharging powder, liquid, and/or gel materials and having at least one opening facing the transport belt. In an embodiment, the dispenser 68 is a powder dispenser capable of discharging a powder. The powder material discharged from the dispenser immediately melts upon contacting the preheated device, such that additional resin particles can be electrostatically attracted to the device. In an alternative embodiment, the dispenser 68 is capable of discharging a liquid and/or gel material. The liquid or gel material, which can additionally include solid particulates dispersed therein, flows downward from the initial point of deposit to form a pool or patch at the bottom of the device. The flow rate of the liquid or gel material varies by the viscosity and weight of the material. The dispenser 68 includes or is connected to a reservoir (not shown) that contains a supply of the retention element material in the desired form, and is capable of delivering a discrete, precisely metered amount of the material in succession during an operation.

Any suitable dispenser capable of dispensing the retention element material can be used. For example, in embodiments that include reactive hot melt as the base polymer, known dispensers for reactive hot melts, such as Nordson® Durapail or BM 20 series machines, available from Nordson Engineering GmbH of Lüneberg, Germany, can be used. Such dispensers preferably provide heating and/or melting of the reactive hot melt before dispensing, such that the reactive hot melt is dispensed as a liquid.

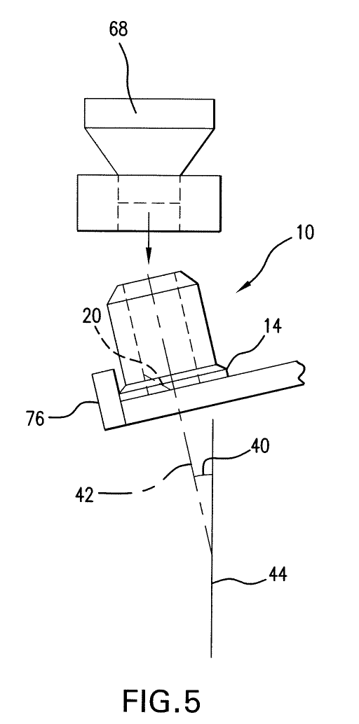

Preferably, the dispenser deposits the material at an angle from the surface of the device onto which the material is applied. Referring to FIG. 5, a collar 10 placed on the transport belt 60 is shown. The collar 10 and the transport belt 50 are placed at an angle from the dispenser 68. An end wall 76 is provided on the transport belt 60 to ensure that the collar 10 does not slide off the transport belt 60. The dispenser 68 dispenses a metered dose of the retention element material onto an interior surface 16 of the collar 10 at an angle 40 relative to the axis 42 of the collar 10, the angle 40 being the difference between the vertical axis 44 and the axis 42 of the collar 10. Depositing the retention element material at an angle provides greater surface coverage and ensures that any retention element material in liquid or gel form stays in contact with a portion of the interior surface 16. In an embodiment, the angle 42 is about 10 to 60°. Preferably, the angle is about 20 to 50°. Most preferably, the angle is about 30 to 45°.

In a preferred embodiment, the dispenser is capable of controlling the amount, direction and speed of each metered shot of material that it deposits. The dispenser preferably also has the capability of metering a high number of discrete shots of the material per unit of time and providing consistent clog-free operation and efficient cut-off of material flow. For a typical steel collar having a diameter of ⅝ inches, with an inner diameter of about 0.650 to 0.665 inches, outer diameter of about 0.970 to 1.010 inches, and a height of about 0.929 to 0.959 inches, the retention element material is applied in an amount of about 0.03 to 0.07 g, preferably about 0.05 g. In this embodiment, the dispenser is capable of operating at a speed of at least about 50 to 200 applications (discharges) per minute.

The dispenser is attached to a station that supports a single or multiple dispensers. A single dispenser produces a single deposit of the material on each fastening device passing under the dispenser, while multiple dispensers can be used to speed up the production process, to deposit different types or forms of materials, or to make multiple deposits of the material for various effects. The station can also include additional mechanical features, such as a means for adjusting the angle of the dispenser along the vertical axis, a means for moving the powder dispenser rotationally or linearly about its point of attachment, and a means for moving the station rotationally or linearly. Many known stations can be utilized in connection with the dispenser of the invention, including those providing selective adjustment of the position of the dispenser along different axes.

The dispenser and/or the station can also include a means for controlling the speed of discharge. For example, according to an embodiment, the dispenser is configured to continuously discharge a metered amount of the material at a pre-set time or speed that conforms to the speed of the fastening devices moved on a transport belt. The pre-set speed of the dispenser can be adjusted, depending on the size of the fastening device, speed of the transport belt, and the amount and type of the material being discharged.

In an alternative embodiment, the station serves as a point of attachment for a sensor, such as an optical sensor, which can be used to automatically detect the presence of a fastening device. Once the presence of a device is sensed, the sensor sends a signal, causing a precisely metered shot of the material to discharge from the dispenser when it is indicated that a device is appropriately located under the opening of the dispenser. The sensor is therefore in communication with the electro-pneumatic firing mechanism of the dispenser to control the timing of the output of the material therefrom, such that the dispenser fires precisely timed shots or droplets of the material in response to an indication from the sensor that a device is present and properly aligned under the dispenser. A number of known sensors are acceptable for this purpose.

After the material is deposited on the fastening devices 50, the devices 50 are transported to a second heating station 70, where the devices and the deposited retention element material are heated to a point of fusion or melting point of the base polymer of the retention element material. For example, where the base polymer is ethylene acrylic acid copolymer having a melting point of about 275° F. and is provided as a powder, the heating station 70 heats the device and the retention element material to about 275° F., at which point the powder liquefies. The heat wets out the polymer such that it melts and adheres to the interior wall of the device. When the retention element material is applied in the powder form, the heat melts and liquefies the powder such that the liquefied material flows around and downward from the initial point of deposit, forming a patch adhered to an internal surface of the device. Alternatively, when the retention element material is applied in the liquid or gel form, the heat further enhances the mobility and flowability of the material. In certain embodiments in which the retention element material is applied in the liquid form, this heating step can be omitted, depending on the types of materials used in the retention element material. For example, when a reactive hot melt is used in the retention element material, this reheating step is typically not used.

Heating can be provided by any suitable heating means, including induction, radiation, conduction, and convection, using a heater such as an induction heater, an infrared heater, an oven or a furnace, a heat bath, a light source (e.g., a laser or lamp), and a flame. In an example, heating is provided by a forced air heating system, such as a Leister heater.

After the fastening devices 50 leave the heating station 70, they are cooled to cure and set the heated retention element material, which solidifies and forms a firm bond with the device. Cooling can be achieved using any suitable cooling means, including those that utilize air or water or other liquids at about ambient or cooler temperatures. When the base polymer includes a polymer that is cured by moisture, e.g., a urethane reactive hot melt, cooling with a liquid can further accelerate the curing of the polymer. In the embodiment shown in FIG. 4, the melted retention element is cooled by quenching with water, by passing the devices through a water fall system 72, which includes a water tank 74 and one or more nozzles (not shown) that is connected to the water tank 74. The nozzles spray cooling fluid onto the fastening devices that pass thereunder, whereby the retention element material sets to form a patch-like solid on an interior surface of the device. Instead of water, any other suitable liquid can be utilized. In another embodiment, the fastening devices are cooled by blowing a stream of cooling air onto the devices.

The cooled devices can be dried in air or can be directed to a dryer to dry any cooling liquid remaining on the devices prior to being packaged for subsequent storage and shipment.

It will be appreciated that the present process for applying the retention element can be adjusted or adapted depending on the types of the fastening device 50 and the materials used in the retention element material.

Advantageously, the present process can be adapted to apply any desired amount of the retention element material on a fastening device of any size and configuration that includes a bore or an opening. Further, the process can be adapted for productions of any scale. For mass production, for example, the speeds of the belt and the dispenser can be adjusted such that hundreds or thousands of devices with retention element are formed per hour.

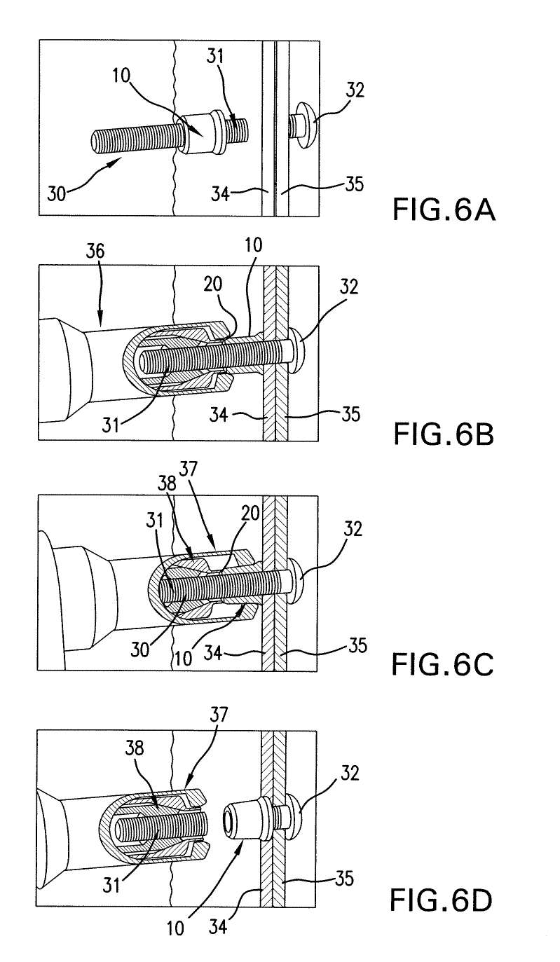

FIGS. 6A to 6D illustrate an embodiment of the invention where the fastening device is a rivet collar. To fasten work pieces with the rivet, a preferred rivet pin 30, preferably having a surface configured to engage the collar once deformed, such as ridged or threaded surface 31, is inserted through holes of work pieces 34, 35 being fastened as shown in FIG. 6A, such that the head 32 of the pin 30 abuts the work piece 35. The collar 10 is placed over the pin 30, such that the retention element 20 extending from the collar 10 frictionally engages the pintail of the pin 30. In one embodiment, the collar 10 includes a flange 14, which can be placed such that the flange 14 abuts the work piece 34.

To set the rivet, an installation tool 36 having a swaging mechanism such as a nose assembly 37 and a grip mechanism such as chuck jaws 38 is placed over the pintail of the pin 30, as shown in FIG. 6B. When the tool 36 is operated, the grip mechanism, e.g., the chuck jaws 38, grips the grooves of the pintail and pulls rearward, as shown in FIG. 6C, thus pulling the pin 30 into the holes and removing any gap between each of the collar and the work pieces 34, 35. The swaging mechanism, e.g., the nose assembly 37, moves forward to swage the collar 10 into the locking groves of the pin 30, plastically deforming the collar to lengthen and squeeze to tighten clamp around the pin. When swaging of the collar is complete, the tool 36 continues to pull until the pintail breaks flush with the top of the collar, as shown in FIG. 6D.

In other embodiments, other types of rivets can be used.

The above description and the following example are illustrative only and are not restrictive or limiting.

### EXAMPLES

### Example 1

### Preparation of a Collar with a Retention Element

Two types of retention element materials comprising ethylene acrylic acid copolymer as the base polymer were prepared and provided on flanged collars. One of the retention element materials was made with Corvel® as the base polymer. The other retention element material comprised a blend of 70% polyethylene and 30% polyethyl methacrylate, a diacrylic compound as an adhesion promoter, and azal amid dicarbon as a blowing agent.

The collars were carbon steel collars with zinc chromate finish manufactured by Huck Manufacturing Company, Irvine, Calif. The collars had a ⅝ inch diameter (with an inner diameter of about 0.650 to 0.665 inches and an outer diameter of about 0.970 to 1.010 inches) and a height of about 0.929 to 0.959 inches.

After preheating the collars to 400° F., the retention element materials were applied to the collars, with each collar receiving one of the two retention element materials. The retention element materials were applied as a powder of about 200 mesh. About 0.05 g of a retention element material was deposited on an interior surface of each collar, at about 3/16 inches from the top (flanged end). The material was deposited at about 30° angle against the axis of the collar. After the application, the collars were heated to about 275° F. by passing through Leister heaters. The heat caused the deposited retention element material to wet out and flow downward to form a shell-like shape at the bottom end of the collar. The collars and the adhered retention elements were then cooled by quenching with water, upon which the retention elements solidified.

The retention elements on the collars were stable in high temperature conditions, and did not disintegrate or become tacky under 350° F.

### Example 2

### Tensile Strength of a Retention Element Made with Urethane Reactive Hot Melt

A retention element material comprising PUR-FECT LOK® 475A urethane reactive hot melt (manufacturer no. 91-475A) as the base polymer was prepared and applied on a flanged collar. The collar was a carbon steel collar with zinc chromate finish manufactured by Huck Manufacturing Company, Irvine, Calif. The collar had a ⅝ inch diameter (with an inner diameter of about 0.650 to 0.665 inches and an outer diameter of about 0.970 to 1.010 inches) and a height of about 0.929 to 0.959 inches. The retention element material was deposited as a liquid, at an angle against the axis of the collar, and was allowed to cure in the air.

The resulting retention element exhibited the following tensile strengths:

| | Installation | Tensile |
|---|---|---|
| | Load (lb.) | Strength (p.s.i.) |
| | 14.5 | 41.4 |
| | 14.7 | 28.4 |
| | 18.9 | 37.9 |
| | 13.6 | 32.7 |
| | 15.1 | 39.9 |
| | 20.2 | 67.7 |
| | 14.3 | 42.0 |
| | 22.9 | 57.2 |
| | 13.8 | 43.2 |
| | 14.0 | 35.3 |
| | 14.7 | 42.8 |
| | 17.3 | 37.8 |
| | 22.6 | 50.2 |
| | 17.3 | 50.3 |
| | 12.8 | 35.3 |
| Maximum | 22.9 | 67.7 |
| Minimum | 12.8 | 28.4 |
| X-Bar | 16.4 | 42.8 |
| Std. Dev. | 3.3 | 10.1 |

As used herein, the term “about” should generally be understood to refer to both the corresponding number and a range of numbers. Moreover, all numerical ranges herein should be understood to include each whole integer within the range. While illustrative embodiments of the invention are disclosed herein, it will be appreciated that numerous modifications and other embodiments may be devised by those skilled in the art. For example, the features for the various embodiments can be used in other embodiments. Therefore, it will be understood that the appended claims are intended to cover all such modifications and embodiments that come within the spirit and scope of the present invention.

What is claimed is:

1. A fastening device, comprising:
a first, female fastener portion comprising an interior surface that defines a bore configured and dimensioned to receive a second, male fastener portion; and
a retention element associated with the internal surface, comprising a heat resistant polymer, and adapted to frictionally engage the second fastener portion sufficiently to prevent or inhibit the fastener portions from coming apart unintentionally.

2. The fastening device of claim 1, further comprising the second, male fastener portion, which is configured and dimensioned for reception within the bore.

3. The fastening device of claim 2, wherein at least one of the first and second fastening portions is configured to be plastically deformed about the other to set the fastener portions in a fixed engagement.

4. The fastening device of claim 2, wherein the retention element is adapted for frictionally engaging and retaining the second portion within the bore sufficiently weakly to allow the fastener portions to be pulled apart from each other prior to setting the first and second fastener portions in a final engaged association.

5. The fastening device of claim 4, wherein the retention element is configured to withstand a pull-off force of up to about 3 lb. without substantially sliding on the second fastener portion in a direction tending to separate the fastener portions prior to setting the first and second fastener portions in a final engaged association.

6. The fastening device of claim 5, wherein the retention element is adapted for frictionally engaging and retaining the second portion within the bore sufficiently weakly to allow the fastener portions to be pulled apart from each other by hand prior to setting the first and second fastener portions in a final engaged association.

7. The fastening device of claim 2, wherein:
the first fastener portion comprises a rivet collar; and
the second fastener portion comprises a rivet pin.

8. A method of fastening a work piece having a hole therein, which method comprises:
providing the fastening device of claim 7;
inserting the second fastener portion through the opening in the work piece and the bore of the first fastener portion; and
setting the fastener portions in a fixed engagement by plastically deforming at least one of the fastener portions about the other.

9. The fastening device of claim 2, wherein the retention element is configured and made so that it does not melt or become tacky up to at least about 150° F.

10. The fastening device of claim 2, wherein the heat resistant polymer is a reactive hot melt or an ethylene acrylic acid copolymer.

11. The fastening device of claim 2, wherein the heat resistant polymer is a urethane reactive hot melt.

12. The fastening device of claim 2, wherein the heat resistant polymer is a polymer blend comprising polyethylene and polyethyl methacrylate.

13. The fastening device of claim 12, wherein the polymer blend comprises the polyethylene in an amount of about 50 to 75% and the polyethyl methacrylate in an amount of about 25 to 50%, by weight of the blend.

14. The fastening device of claim 13, wherein the retention element further comprises at least one additive selected from an adhesion promoting agent, a blowing agent, and a combination thereof.

15. The fastening device of claim 2, wherein the heat resistant polymer is cross-linked and the retention element further comprises a diacrylic compound in an amount selected to promote adhesion with the interior surface and is formed using a blowing agent.

16. The fastening device of claim 1, wherein the retention element is made using a cross-linking agent, an azal amid dicarbon as a blowing agent, and a diacrylic compound in an amount selected to promote adhesion with the interior surface.

17. A method of making a fastening device, comprising:
applying retention element material comprising a heat resistant polymer onto an interior surface of a bore of a first fastener portion, the first fastener portion being configured and dimensioned to receive a second fastener portion;
heating the retention element material at least to the melting point or flow point of the heat resistant polymer to liquefy or to increase the flowability of the retention element material; and
cooling the heated material to set the retention element material to provide a retention element associated with the interior surface that is adapted to frictionally engage the second fastener portion sufficiently to prevent or inhibit the fastener portions from coming apart unintentionally.

18. The method of claim 17, further comprising preheating the first fastener portion to a temperature above the melting point or flow point of the heat resistant polymer.

19. The method of claim 18, wherein the retention element material is provided in a powder form and is heated at least to the melting point of the heat resistant polymer to liquefy the powder retention element material during the heating step.

20. The method of claim 17, wherein the retention element material comprises a cross-linking agent, an adhesion promoting agent, a blowing agent, or a combination thereof.

21. The method of claim 20, wherein the adhesion promoting agent is a diacrylic compound and the blowing agent is an azal amid dicarbon.

22. The method of claim 17, wherein the heat resistant polymer is a reactive hot melt or an ethylene acrylic acid copolymer.

23. The method of claim 17, wherein the heat resistant polymer is a polymer blend comprising polyethylene and polyethyl methacrylate.

24. The method of claim 23, wherein the polymer blend comprises the polyethylene in an amount of about 50 to 75% and the polyethyl methacrylate in an amount of about 25 to 50%, by weight of the blend.

25. The method of claim 17, wherein the first fastener portion comprises a rivet collar configured and dimensioned for receiving a rivet pin, and the heat resistant polymer comprises a reactive hot melt, an ethylene acrylic acid copolymer, a polyethylene blend, or a combination thereof.
